(19) United States
(12) Patent Application Publication
(10) Pub. No.: US 2021/0064353 A1
(43) Pub. Date: Mar. 4, 2021

(54) ADAPTIVE PROGRAM EXECUTION OF COMPILER-OPTIMIZED MACHINE CODE BASED ON RUNTIME INFORMATION ABOUT A PROCESSOR-BASED SYSTEM

(71) Applicant: Microsoft Technology Licensing, LLC, Redmond, WA (US)

(72) Inventors: Rami Mohammad AL SHEIKH, Morrisville, NC (US); Michael Scott MCILVAINE, Raleigh, NC (US)

(21) Appl. No.: 16/559,990

(22) Filed: Sep. 4, 2019

(51) Int. Cl. G06F 8/41; G06F 9/30; G06F 9/38

(52) U.S. Cl. CPC G06F 8/4441; G06F 9/3846; G06F 9/30058

(57) ABSTRACT

Instructions for execution by a processor in a processor-based system are generated such that multiple compiler generated instruction blocks are provided for a given functional block of source code. Control flow instructions are provided to control the flow of execution between the compiler generated instruction blocks based on runtime information about the processor-based system. By providing multiple compiler generated instruction blocks and the control flow instructions, the one of the compiler generated instruction blocks that will provide the best performance for the processor-based system at the time of execution can be executed. Accordingly, the performance of the processor-based system can be improved.

### FIELD OF THE DISCLOSURE

The present disclosure is related to execution of instructions by a computer processor in a processor-based system, and more particularly to systems and methods for improving the performance of the processor during execution of the instructions based on runtime information about the processor-based system.

### BACKGROUND

Computer processors perform computational tasks for a wide variety of applications. A processor executes computer program instructions, referred to more generally as instructions, to fetch data from memory, perform one or more operations using the fetched data, and generate a result. The result may then be stored in memory or provided to another consumer instruction for consumption.

The instructions are generated by a compiler from source code. The compiler receives the source code, generates an intermediate representation of the source code, and performs one or more compiler optimizations on the source code to generate the instructions as machine code. The source code includes a number of functional blocks. For each functional block the compiler must decide whether to apply one or more compiler optimizations. In some scenarios, a compiler optimization may improve the performance of the processor when executing the instructions, but in other scenarios the same compiler optimization may decrease performance. For example, in one scenario a compiler optimization may decrease power consumption and/or execution time. However, in another scenario the same compiler optimization may increase power consumption and/or execution time. Whether or not a compiler optimization will improve or diminish performance depends on the processor itself, the system in which the processor is provided, and the operating context of the processor. At the time the source code is compiled, the compiler does not have enough information about the processor and the system in which the processor is integrated to know whether a given compiler optimization will result in improved performance of the processor when the instructions are executed or decreased performance. Accordingly, the compiler must guess whether a compiler optimization will improve performance and thus should be applied. Often, the compiler guesses wrong and thus generates instructions that are not optimized for a given processor. Accordingly, there is a need for systems and methods for improving the performance of instruction execution on a processor.

### SUMMARY

Exemplary aspects of the present disclosure are related to systems and methods for generating and executing machine code that is optimized for a processor in a processor-based system based on runtime information about the processor-based system. The processor is configured to fetch one or more instructions from an instruction memory. The one or more instructions include a first compiler generated instruction block, a second compiler generated instruction block, and control flow instructions to control the flow of execution between the first compiler generated instruction block and the second compiler generated instruction block. The first compiler generated instruction block and the second compiler generated instruction block are generated by a compiler from the same functional block of source code with different compiler optimizations. The control flow instructions do not correspond to any source code, but rather are inserted by the compiler to cause the processor to execute the one of the compiler generated instruction blocks that is optimal for the processor at the time of execution. Accordingly, the control flow instructions cause the processor to execute one of the compiler generated instruction blocks based on runtime information about the processor-based system.

In another exemplary aspect, the control flow instructions include a conditional branch instruction comprising a condition operand corresponding to runtime information about the processor-based system and a target address operand, where the first compiler generated instruction block is at the target address of the conditional branch instruction, and the second compiler generated instruction block is following the conditional branch instruction. The processor is configured to process the conditional branch instruction to determine a condition of the condition operand based on the runtime information about the processor-based system and, in response to the determined condition indicating a branch taken, execute the first compiler generated instruction block. In one exemplary aspect, in response to the determined condition not indicating a branch not taken, the processor is configured to execute the second compiler generated instruction block. By using runtime information about the processor-based system to selectively execute the first compiler generated instruction block or the second compiler generated instruction block, the one of the instruction blocks that will provide the best performance for the processor at the time of execution is executed.

In another exemplary aspect, the runtime information about the processor-based system comprises information available to the processor at the time of execution of the one or more instructions that was not known at the time the one or more instructions were generated by a compiler. The runtime information may include a performance characteristic of the processor-based system or information about a hardware resource of the processor-based system.

In another exemplary aspect, the first compiler generated instruction block is functionally equivalent to the second compiler generated instruction block. The first compiler generated instruction block may be generated without compiler optimizations, while the second compiler generated instruction block may be generated using at least one compiler optimization.

In another exemplary aspect, the runtime information about the processor-based system comprises information about the processor-based system before the first compiler generated instruction block is executed and information about the processor-based system after the first compiler generated instruction block is executed.

In another exemplary aspect, the runtime information includes at least two different pieces of information about the processor-based system.

In another exemplary aspect, a method for generating instructions for execution by the processor in the processor-based system includes receiving source code and generating instructions from the source code. The instructions include control flow instructions, a first compiler generated instruction block, and a second compiler generated instruction block. The first compiler generated instruction block and the second compiler generated instruction block are generated from the same functional block of source code. The control flow instructions do not correspond to any source code, but rather are inserted by the compiler to control the flow of execution between the first compiler generated instruction block and the second compiler generated instruction block such that the processor is able to execute the one of the compiler generated instruction blocks that is optimal for the processor at the time of execution. Accordingly, the control flow instructions cause the processor to execute one of the compiler generated instruction blocks based on runtime information about the processor-based system.

In another exemplary aspect, the control flow instructions include a conditional branch instruction comprising a condition operand corresponding to runtime information about the processor-based system and a target address operand. The first compiler generated instruction block is at the target address of the conditional branch instruction. The second compiler generated instruction block is following the conditional branch instruction. By generating the instructions in this manner, execution of the first compiler generated instruction block and the second compiler generated instruction block can be dynamically chosen by the processor such that the instruction block that will provide the best performance at the time of execution is executed.

Those skilled in the art will appreciate the scope of the present disclosure and realize additional aspects thereof after reading the following detailed description of the preferred embodiments in association with the accompanying drawing figures.

### BRIEF DESCRIPTION OF THE DRAWING FIGURES

The accompanying drawing figures incorporated in and forming a part of this specification illustrate several aspects of the disclosure, and together with the description serve to explain the principles of the disclosure.

FIG. 1 is a block diagram illustrating an exemplary processor-based system that includes a processor configured to perform runtime adaptive program execution of compiler-optimized machine code based on runtime information about the processor-based system;

FIG. 2 is a block diagram illustrating exemplary details of a processor in a processor-based system in FIG. 1 performing runtime adaptive program execution of compiler-optimized machine code based on runtime information about the processor-based system;

FIG. 3 is a block diagram illustrating an exemplary compiler system for compiling source code into compiler-optimized machine code for execution by a processor in a processor-based system;

FIG. 4 illustrates exemplary source code and machine code compiled from source code by a compiler, where the machine code is unoptimized in one version and optimized using a compiler optimization in another version;

FIG. 5 is a flowchart illustrating an exemplary process of a compiler generating compiler-optimized machine code for execution by the processor in a processor-based system based on runtime information about the processor;

FIG. 6 illustrates exemplary compiler-optimized machine code generated from source code, where the machine code includes one or more control flow instructions for controlling execution flow between a first compiler generated instruction block and a second compiler generated instruction block based on runtime information about the processor-based system in which the machine code is executed;

FIG. 7 is a flowchart illustrating an exemplary process for generating machine code for execution by a processor in a processor-based system, where the execution of the machine code is optimized for the processor using runtime information about the processor-based system;

FIG. 8 is a flowchart illustrating an exemplary process for executing instructions from compiler-optimized machine code on a processor in a processor-based system;

FIG. 9 is a flowchart illustrating an exemplary process for executing instructions from compiler-optimized machine code on a processor in a processor-based system; and

FIG. 10 is a block diagram illustrating an exemplary processor-based system that includes a processor configured to perform runtime adaptive program execution of compiler-optimized machine code based on runtime information about the processor-based system.

### DETAILED DESCRIPTION

Exemplary aspects of the present disclosure are related to systems and methods for generating and executing machine code that is optimized for a processor in a processor-based system based on runtime information about the processor-based system. The processor is configured to fetch one or more instructions from an instruction memory. The one or more instructions include a first compiler generated instruction block, a second compiler generated instruction block, and control flow instructions to control the flow of execution between the first compiler generated instruction block and the second compiler generated instruction block. The first compiler generated instruction block and the second compiler generated instruction block are generated by a compiler from the same functional block of source code with different compiler optimizations. The control flow instructions do not correspond to any source code, but rather are inserted by the compiler to cause the processor to execute the one of the compiler generated instruction blocks that is optimal for the processor at the time of execution. Accordingly, the control flow instructions cause the processor to execute one of the compiler generated instruction blocks based on runtime information about the processor-based system.

In another exemplary aspect, a method for generating instructions for execution by the processor in the processor-based system includes receiving source code and generating instructions from the source code. The instructions include control flow instructions, a first compiler generated instruction block, and a second compiler generated instruction block. The first compiler generated instruction block and the second compiler generated instruction block are generated from the same functional block of source code. The control flow instructions do not correspond to any source code, but rather are inserted by the compiler to control the flow of execution between the first compiler generated instruction block and the second compiler generated instruction block such that the processor is able to execute the one of the compiler generated instruction blocks that is optimal for the processor at the time of execution. Accordingly, the control flow instructions cause the processor to execute one of the compiler generated instruction blocks based on runtime information about the processor-based system.

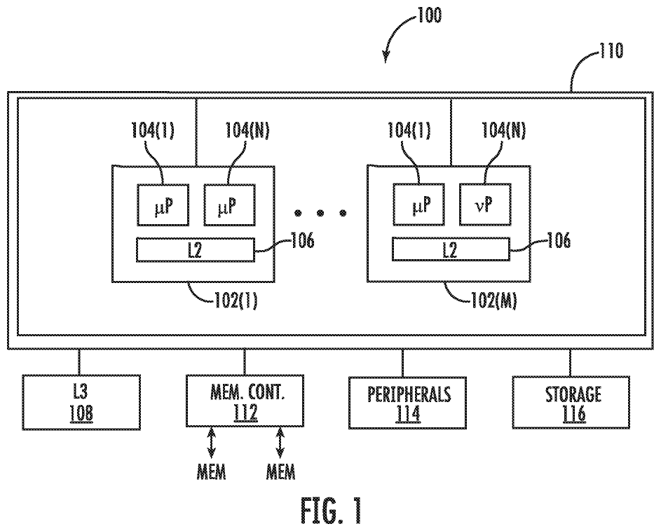

FIG. 1 is a schematic diagram of an exemplary processor-based system 100. The processor-based system 100 includes a number of processor blocks 102(1)-102(M), wherein in the present exemplary embodiment ‘M’ is equal to any number of processor blocks 102 desired. Each processor block 102 contains a number of processors 104(1)-104(N), wherein in the present exemplary embodiment ‘N’ is equal to any number of processors desired. The processors 104 in each one of the processor blocks 102 may be microprocessors (μP), vector processors (vP), or any other type of processor. Further, each processor block 102 contains a shared level 2 (L2) cache 106 for storing cached data that is used by any of, or shared among, each of the processors 104. A shared level 3 (L3) cache 108 is also provided for storing cached data that is used by any of, or shared among, each of the processor blocks 102. An internal bus system 110 is provided that allows each of the processor blocks 102 to access the shared L3 cache 22 as well as other shared resources such as a memory controller 112 for accessing a main, external memory (MEM), one or more peripherals 114 (including input/output devices, networking devices, and the like), and storage 116.

In operation, one or more of the processors 104 in one or more of the processor blocks 102 work with the memory controller 112 to fetch instructions from memory, execute the instructions to perform one or more operations and generate a result, and optionally store the result back to memory or provide the result to another consumer instruction for consumption. As discussed above, if the instructions fetched from memory are not optimized for the processor 104 executing them, the performance of the processor-based system 100 will suffer.

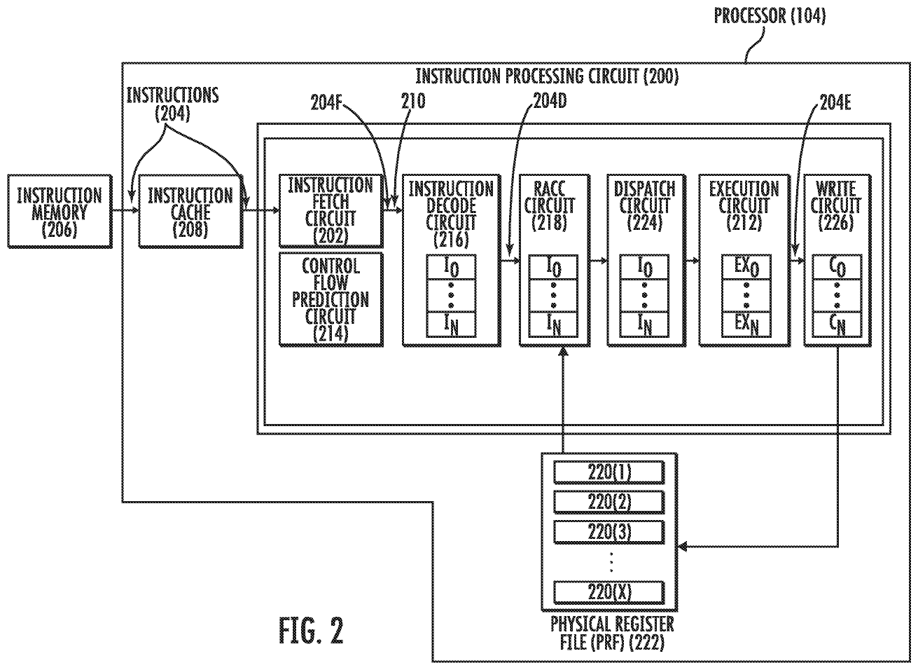

FIG. 2 shows details of a processor 104 in a processor block 102 of the processor-based system 100 according to an exemplary embodiment of the present disclosure. The processor 104 includes an instruction processing circuit 200. The instruction processing circuit 200 includes an instruction fetch circuit 202 that is configured to fetch instructions 204 from an instruction memory 206. The instruction memory 206 may be provided in or as part of a system memory in the processor-based system 100 as an example. An instruction cache 208 may also be provided in the processor 104 to cache the instructions 204 fetched from the instruction memory 206 to reduce latency in the instruction fetch circuit 202. The instruction fetch circuit 202 in this example is configured to provide the instructions 204 as fetched instructions 204F into one or more instruction pipelines I₀-I_{N} as an instruction stream 210 in the instruction processing circuit 200 to be pre-processed, before the fetched instructions 204F reach an execution circuit 212 to be executed. The instruction pipelines I₀-I_{N} are provided across different processing circuits or stages of the instruction processing circuit 200 to pre-process and process the fetched instructions 204F in a series of steps that can be performed concurrently to increase throughput prior to execution of the fetched instructions 204F in the execution circuit 212.

A control flow prediction circuit 214 (e.g., a branch prediction circuit) is also provided in the instruction processing circuit 200 in the processor 104 to speculate or predict a target address for a control flow fetched instruction 204F, such as a conditional branch instruction. The prediction of the target address by the control flow prediction circuit 214 is used by the instruction fetch circuit 202 to determine the next fetched instructions 204F to fetch based on the predicted target address. The instruction processing circuit 200 also includes an instruction decode circuit 216 configured to decode the fetched instructions 204F fetched by the instruction fetch circuit 202 into decoded instructions 204D to determine the instruction type and actions required, which may also be used to determine in which instruction pipeline I₀-I_{N} the decoded instructions 204D should be placed. The decoded instructions 204D are then placed in one or more of the instruction pipelines I₀-I_{N} and are next provided to a register access circuit 218.

The register access circuit 218 is configured to access a physical register 220(1)-220(X) in a physical register file (PRF) 222 to retrieve a produced value from an executed instruction 204E from the execution circuit 212. The register access circuit 218 is also configured to provide the retrieved produced value from an executed instruction 204E as the source register operand of a decoded instruction 204D to be executed. The instruction processing circuit 200 also includes a dispatch circuit 224, which is configured to dispatch a decoded instruction 204D to the execution circuit 212 to be executed when all source register operands for the decoded instruction 204D are available. For example, the dispatch circuit 224 is responsible for making sure that the necessary values for operands of a decoded consumer instruction 204D, which is an instruction that consumes a produced value from a previously executed producer instruction, are available before dispatching the decoded consumer instruction 204D to the execution circuit 212 for execution. The operands of the decoded instruction 204D can include intermediate values, values stored in memory, and produced values from other decoded instructions 204D that would be considered producer instructions to the consumer instruction.

The execution circuit 212 is configured to execute decoded instructions 204D received from the dispatch circuit 224. As discussed above, the executed instructions 204E may generate produced values to be consumed by other instructions. In such a case, a write circuit 226 writes the produced values to the PRF 222 so that they can be later consumed by consumer instructions.

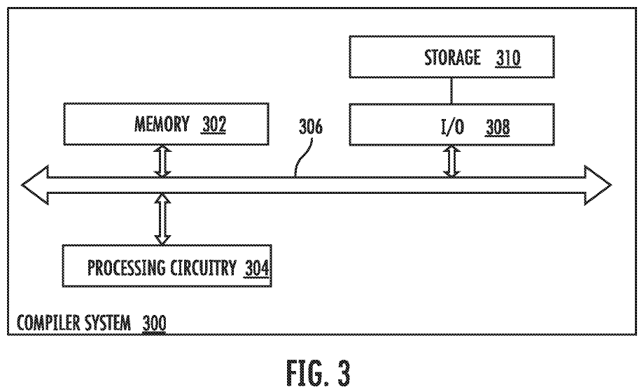

The instructions fetched, decoded, and executed by the processor 104 as discussed above are generated by a compiler. FIG. 3 illustrates an exemplary compiler system 300. The compiler system 300 includes a memory 302 and processing circuitry 304. The memory 302 and the processing circuitry 304 are connected via a bus 306. As discussed below, the memory 302 stores instructions, which, when executed by the processing circuitry 304 cause the compiler system 300 to retrieve or otherwise receive source code, generate an intermediate representation of the source code, apply one or more compiler optimizations to the intermediate representation of the source code, and provide the optimized intermediate representation of the source code as machine code suitable for execution by a processor in a processor-based system. For purposes of discussion, the operation of the compiler system 300 will be described as it relates to compiling source code into machine code for the processor 104 in the processor-based system 100. However, the compiler system 300 may more generally compile source code into machine code suitable for any processor in any processor-based system, including several different processors for several different processor-based systems. According to various embodiments of the present disclosure, the memory 302 may include instructions, which, when executed by the processing circuitry 304 cause the compiler system 300 to generate machine code including a number of compiler generated instruction blocks for a given functional block of source code, each one of the compiler generated instruction blocks having different compiler optimizations applied thereto, and control flow instructions to control the flow of execution between the compiler generated instruction blocks based on runtime information about the processor-based system 100 in which the machine code is executed. The compiler system 300 may further include an input/output controller 308, which may be coupled to storage 310 for storing the source code or otherwise allow the source code to be provided to the compiler system 300.

Compiler optimizations are transformations done on the intermediate representation of the source code that are designed to improve the performance of the processor 104 executing the machine code. Examples of compiler optimizations include predication, code refactoring, dead code elimination, loop unrolling, and the like. The intermediate representation of the source code may include a number of functional blocks (e.g., functions, loops, etc.), which may or may not overlap with one another. Conventionally, for each functional block in the source code, the compiler system 300 generates a single compiler generated instruction block. The compiler system 300 must decide whether or not to apply a compiler optimization to a given functional block when generating the single compiler generated instruction block corresponding to the functional block of source code. For a given functional block, compiler optimizations may cause the instructions generated by the compiler system 300 for the functional block to be executed by the processor 104 with improved performance (e.g., decreased execution time and reduced power consumption) or diminished performance. The compiler system 300 attempts to apply compiler optimizations only when it is certain that they will improve performance.

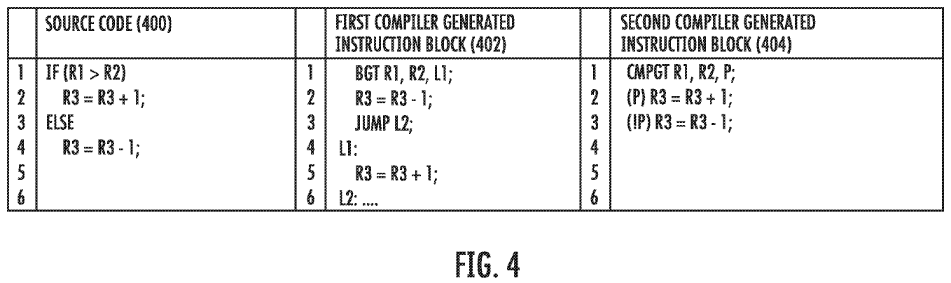

FIG. 4 illustrates an exemplary compiler optimization applied to a functional block of source code 400. The functional block of source code 400 includes an if instruction and an else instruction. The functional block of source code 400 dictates that if the value of R1 is greater than R2, the value of R3 should be incremented. If the value of R1 is not greater than R2, the value of R3 should be decremented. A first compiler generated instruction block 402 for the functional block of source code 400 includes a conditional branch instruction (BGT), which instructs the processor 104 to branch to location L1 if the value of R1 is greater than R2. At location L1, the value of R3 is incremented. Accordingly, if the conditional branch instruction indicates that the branch should be taken, execution of the machine code proceeds to location L1 where the value of R3 is incremented. If the conditional branch instruction indicates that the branch should not be taken, the value of R3 is decremented as execution proceeds to the instruction following the conditional branch instruction. A second compiler generated instruction block 404 for the functional block of source code 400 uses predication, which is a compiler optimization. The second compiler generated instruction block 404 includes a predicate compare instruction (CMPGT), which instructs the processor 104 to set the value of P to true if R1 is greater than R2 and set the value of P to false if R1 is not greater than R2. The following instruction increments R3, but only updates the value of R3 if the value of P is true. The following instruction decrements R3, but only updates the value of R3 if the value of P is false. All of the instructions in the second compiler generated instruction block 404 are executed, as there is no branch instruction in the code.

The second compiler generated instruction block 404 shown above will only improve performance of the processor 104 during execution of the instructions if the conditional branch instruction in line 1 of the first compiler generated instruction block 402 is not predictable. This is because when the conditional branch instruction in line 1 is predictable, the critical path through the program is shorter using the first compiler generated instruction block 402. In contrast, when the conditional branch instruction in line 1 is not predictable, the second compiler generated instruction block 404 eliminates the hard-to-predict branch and thus improves performance.

The compiler system 300 will choose to generate either the first compiler generated instruction block 402 or the second compiler generated instruction block 404 for the functional block of source code 400. That is, only one of the first compiler generated instruction block 402 and the second compiler generated instruction block 404 will be in the machine code generated by the compiler system 300 for the functional block of source code 400. As discussed above, the compiler system 300 only has access to compile-time information, which is limited. If the compiler system 300 makes the wrong decision regarding whether to generate the first compiler generated instruction block 402 or the second compiler generated instruction block 404 in the machine code, the performance of the processor 104 will suffer during executing the machine code.

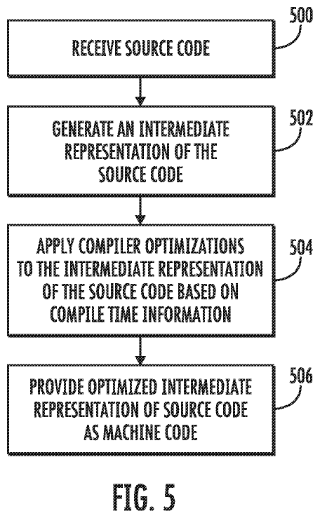

FIG. 5 is a flow diagram illustrating a process for generating instructions for execution by the processor 104 using the compiler system 300 according to one embodiment of the present disclosure. The compiler system 300 receives source code (block 500), such as the source code 400 discussed above with respect to FIG. 4. As an example, the source code may be code written in a high-level programming language such as C, Rust, Go, Swift, and the like. The compiler system 300 generates an intermediate representation of the source code (block 502). An intermediate representation of the source code may be, for example, a data structure representative of the source code that is designed to make further processing of the source code, such as optimization and translation as discussed below, easier. One or more compiler optimizations are applied to the intermediate representation of the source code (block 504) based on compile time information. For example, the compiler system 300 will decide to apply predication to the source code 400 to provide the second compiler generated instruction block 404 or not to apply predication to provide the first compiler generated instruction block 402. The optimized intermediate representation of the source code is provided as machine code (block 506). Following the example above, either the first compiler generated instruction block 402 or the second compiler generated instruction block 404, but not both, will be provided as the machine code. The machine code includes a number of instructions that are suitable for execution by the processor 104 (i.e., the instructions conform to the instruction set architecture (ISA) of the processor 104). The machine code may also be referred to as a binary.

As discussed above, at the time of compilation of the source code the compiler system 300 knows little information about the processor 104 and processor-based system 100. For example, the compiler system 300 may know the ISA of the processor 104 (which may be provided as a parameter to the compiler) but does not and cannot know anything about the runtime state of the processor 104 or the processor-based system 100 at the time the instructions are being executed (e.g., the number of branch mispredictions for a given execution cycle, the availability of one or more hardware resources such as a vector processor, whether or not the processor is in a low power mode of operation, and the like). The information known to the compiler system 300 at the time the source code is compiled is referred to herein as compile-time information. Conventionally and in the present example, compiler optimizations are applied based on compile-time information. Due to the limited nature of compile-time information, it is difficult for the compiler system 300 to know which compiler optimizations will actually improve the performance of the processor 104 during execution of the machine code. The compiler system 300 therefore uses heuristics to determine which compiler optimizations to apply. Due to the fact that a compiler optimization may actually diminish performance if applied in the wrong circumstances, it is advantageous for the compiler system 300 to be conservative when deciding which compiler optimizations are applied. Accordingly, many functional blocks are often left unoptimized when a compiler optimization may improve the performance of execution of the machine code.

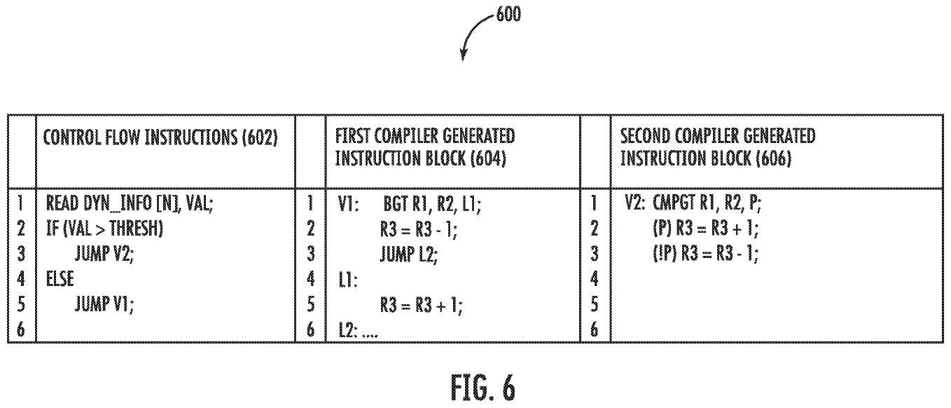

To solve these problems, FIG. 6 illustrates machine code 600 generated by the compiler system 300 from the source code 400 discussed above according to one embodiment of the present disclosure. The machine code 600 is generated to include multiple compiler generated instruction blocks for a given functional block of source code 400 (here, the entirety of the source code 400), each generated using different compiler optimizations, and control flow instructions to control the flow of execution between the compiler generated instruction blocks based on runtime information about the processor-based system. Control flow instructions 602 include a first line that reads runtime information about the processor-based system executing the instructions (READ DYN_INFO[N]) and stores the runtime information to a variable VAL. The runtime information is used in an if-else statement in lines 2-5 to determine whether a first compiler generated instruction block 604 at location V1 is executed or a second compiler generated instruction block 606 at location V2 is executed. Specifically, the control flow instructions 602 specify that if VAL is greater than a threshold value THRESH, that the second compiler generated instruction block 606 will be executed. If VAL is not greater than the threshold value THRESH, the first compiler generated instruction block 604 will be executed. Notably, both the first compiler generated instruction block 604 and the second compiler generated instruction block 606 are provided in the machine code generated by the compiler system 300 such that the processor 104 can dynamically execute either instruction block based on which one will provide better performance at the time of execution.

As discussed above with respect to FIG. 4, the first compiler generated instruction block 604 is an unoptimized compiler generated instruction block (i.e., is merely a translated version of the functional block of source code), while the second compiler generated instruction block 606 is an optimized compiler generated instruction block using predication (i.e., is a translated version of the functional block of source code with one or more compiler optimization transforms applied thereto). The first compiler generated instruction block 604 and the second compiler generated instruction block 606 are generated from the source code 400 shown in FIG. 4. The first compiler generated instruction block 604 and the second compiler generated instruction block 606 are functionally equivalent. That is, the first compiler generated instruction block 604 and the second compiler generated instruction block 606 will generate the same result when executed by the processor. However, as discussed above, the first compiler generated instruction block 604 may be executed with better performance than the second compiler generated instruction block 606, depending on the operating characteristics of the processor 104. The control flow instructions 602 use runtime information about the processor-based system 100 to determine which one of the first compiler generated instruction block 604 and the second compiler generated instruction block 606 to execute. In one example, the runtime information is the number of branch mispredictions by the processor 104 in a given period of time. As discussed above, the second compiler generated instruction block 606, which is generated using predication, will only improve performance of the processor 104 if the conditional branch instruction in the first compiler generated instruction block 604 is not predictable, as it will then eliminate the hard-to-predict branch. The number of branch mispredictions by the processor 104 is indicative of whether the conditional branch instruction is predictable or not. If the number of branch mispredictions by the processor 104 is above a threshold value, this indicates that the conditional branch instruction is not predictable and thus that predicated instructions as provided in the second compiler generated instruction block 606 will provide superior performance compared to non-predicated instructions as provided in the first compiler generated instruction block 604. In contrast, if the number of branch mispredictions by the processor 104 is not above the threshold value, this indicates that the conditional branch instruction is predictable and thus that non-predicated instructions as provided in the first compiler generated instruction block 604 will provide superior performance compared to predicated instructions as provided in the second compiler generated instruction block 606.

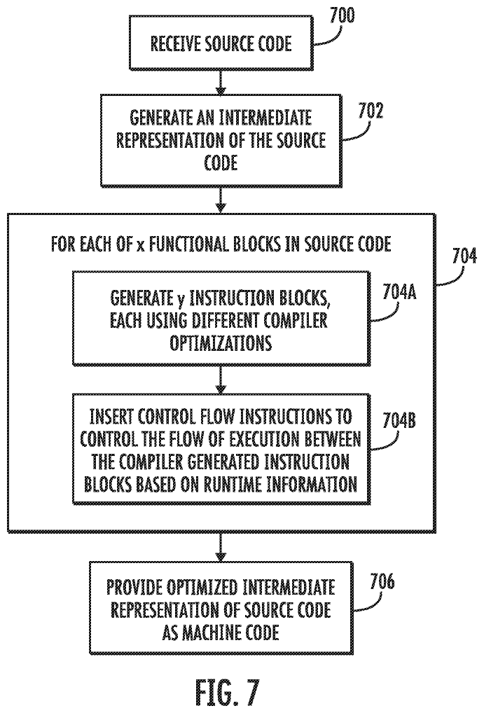

FIG. 7 is a flow diagram illustrating a process for generating instructions for execution by the processor 104 using a compiler system 300 according to one embodiment of the present disclosure. The compiler system 300 receives source code (block 700) such as the source code 400 discussed above with respect to FIG. 4. As discussed above, the source code may be code written in a high-level programming language such as C, Rust, Go, Swift, and the like. The compiler system 300 generates an intermediate representation of the source code (block 702). Further as discussed above, the intermediate representation of the source code may be, for example, a data structure representative of the source code that is designed to make further processing of the source code, such as optimization and translation, easier. One or more compiler optimizations are applied to the intermediate representation of the source code (block 704). The optimized intermediate representation of the source code is provided as machine code (block 706). For example, the compiler system 300 provides the machine code 600 discussed in FIG. 6. The machine code includes a number of instructions that are suitable for execution by a processor 104, and may also be referred to as a binary.

The one or more compiler optimizations are applied to each one of ‘X’ functional blocks in the source code, wherein in the present exemplary embodiment ‘X’ is equal to any number of functional blocks desired. For each one of the functional blocks in the source code, ‘Y’ compiler generated instruction blocks are generated by the compiler system 300 (block 704A), wherein in the present embodiment ‘Y’ is equal to any number of compiler generated instruction blocks desired greater than two. For example, the first compiler generated instruction block 604 and the second compiler generated instruction block 606 may each be generated by the compiler system 300 from the source code 400, which is considered in its entirety as a functional block in the present example (the same step can be applied to any resolution of functional block in the source code). Each one of the compiler generated instruction blocks is functionally equivalent, such that each one of the compiler generated instruction blocks produces the same result when executed by a processor 104. However, each one of the compiler generated instruction blocks is optimized by the compiler system 300 in a different way, such that each one of the compiler generated instruction blocks has a different compiler optimization applied thereto. As an example, a first one of the compiler generated instruction blocks may be unoptimized such that no compiler optimizations are applied thereto (i.e., is merely a translation of the source code into machine code) while a second one of the compiler generated instruction blocks may be optimized using predication (i.e., the source code is translated into machine code and one or more optimizing transforms are applied to the machine code). Such an example corresponds with the first compiler generated instruction block 604 and the second compiler generated instruction block 606.

One or more control flow instructions are provided to control the flow of execution between the compiler generated instruction blocks (block 704B). For example, the control flow instructions 602 are provided. In the simplest example in which two compiler generated instruction blocks are generated for a functional block of source code, the control flow instructions include a conditional branch instruction. The conditional branch instruction includes a condition operand which corresponds to runtime information about the processor-based system 100. Further, the conditional branch instruction includes a target address operand, which points to a first compiler generated instruction block. A second compiler generated instruction block follows the conditional branch instruction such that if the conditional branch instruction indicates that a branch should be taken, the first compiler generated instruction block is executed, and if the conditional branch instruction indicates that a branch should not be taken, the second compiler generated instruction block is executed. The control flow instructions are provided such that the runtime information associated with the processor-based system is used to execute the compiler generated instruction block that will provide the best performance at the time of execution. In cases in which more than two compiler generated instruction blocks are generated for a functional block of source code, the control flow instructions will include more than one conditional branch instruction or any other suitable instructions for controlling the flow of execution between the compiler generated instruction blocks based on runtime information about the processor-based system 100 such that the one of the compiler generated instruction blocks that will provide the best performance at the time of execution is executed by the processor 104.

As discussed herein, runtime information about the processor-based system 100 is information about the processor-based system 100 available to the processor 104 in the processor-based system 100 at the time of execution of the machine code that was not known at the time the machine code was generated by the compiler system 300. As discussed above, compile-time information is much more limited than runtime information. While compile-time information may include basic information such as the ISA of the processor 104, runtime information can include real-time information about the processor 104 and/or the processor-based system 100 such as performance characteristics of the processor 104 for a given period of time (e.g., the number of mispredicted or not predicted branches speculatively executed, the number of cache misses), the availability of a hardware resource of the processor (e.g., the availability of a vector processor, a cache size of the processor), or the like. In some circumstances, a compiler optimization may be advantageous under certain operating characteristics of the processor 104, and disadvantageous otherwise. The machine code generated by the compiler system 300 according to the present embodiment gives the processor 104 access to multiple different versions of the same functional block, each of which is optimized for a particular runtime state of the processor 104. The processor 104 may execute different ones of the compiler generated instruction blocks during different execution cycles. For example, in a first execution of a loop the runtime information associated with the processor-based system 100 may indicate that a first compiler generated instruction block should be executed to optimize the performance of the processor 104, while in a subsequent execution of the loop the runtime information may indicate that a different compiler generated instruction block should be executed to optimize the performance of the processor 104.

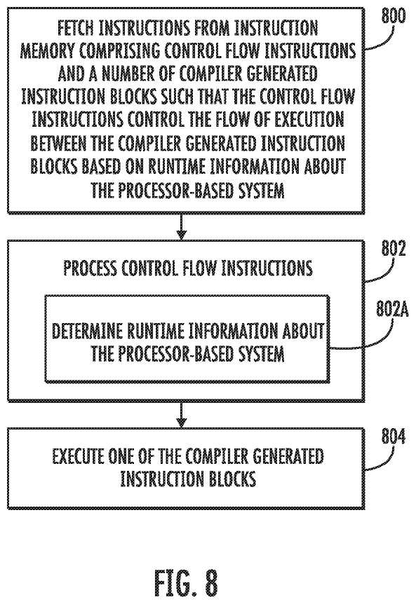

FIG. 8 is a flow diagram illustrating a process for executing instructions that optimize the performance of the processor 104 in the processor-based system 100 according to one embodiment of the present disclosure. For example, the processor 104 may execute the instructions in the machine code 600 discussed above. The processor 104 fetches instructions from an instruction memory (block 800). The instructions include control flow instructions (e.g., control flow instructions 602) and a number of compiler generated instruction blocks (e.g., the first compiler generated instruction block 604 and the second compiler generated instruction block 606). The control flow instructions control the flow of execution between the compiler generated instruction blocks based on runtime information about the processor-based system 100. The processor 104 processes the control flow instructions (block 802) to determine runtime information about the processor-based system 100 (block 802A). For example, the processor 104 may process the instruction READ DYN_INFO[N] in the control flow instructions 602 to determine runtime information about the processor-based system 100. The processor 104 executes one of the compiler generated instruction blocks as directed by the control flow instructions based on the runtime information about the processor-based system 100 (block 804). For example, the processor 104 may execute one of the first compiler generated instruction block 604 or the second compiler generated instruction block 606 based on a comparison of the runtime information to a threshold THRESH as discussed above.

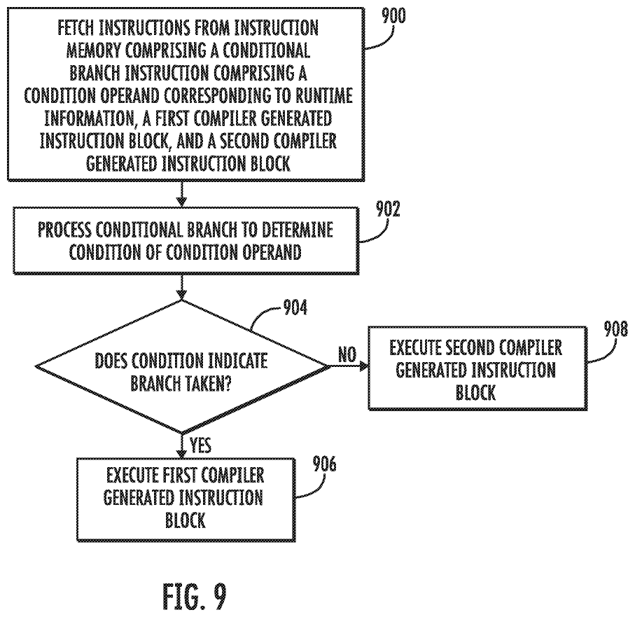

FIG. 9 is a flow diagram illustrating a process for executing instructions that optimize the performance of the processor 104 in the processor-based system 100 according to an additional embodiment of the present disclosure. The process in FIG. 9 is similar to that discussed above with respect to FIG. 8, but is specific to the case in which the instructions include only a first compiler generated instruction block and a second compiler generated instruction block for a given functional block of source code such that the control flow instructions are provided by a conditional branch instruction. The processor 104 fetches instructions from an instruction memory (block 900). The instructions include a conditional branch instruction, a first compiler generated instruction block, and a second compiler generated instruction block. The conditional branch instruction includes a condition operand corresponding to runtime information about the processor-based system 100 and a target address operand. The first compiler generated instruction block is at the target address of the conditional branch instruction. The second compiler generated instruction block is following the conditional branch instruction. The processor 104 processes the conditional branch to determine the condition of the condition operand (block 902). As discussed above, processing the conditional branch to determine the condition of the condition operand includes determining runtime information about the processor-based system 100. The processor 104 evaluates whether the determined condition indicates that a branch should be taken (block 904). If the determined condition indicates that the branch should be taken, the first compiler generated instruction block is executed (block 906). If the determined condition indicates that the branch should not be taken, the second compiler generated instruction block is executed (block 908).

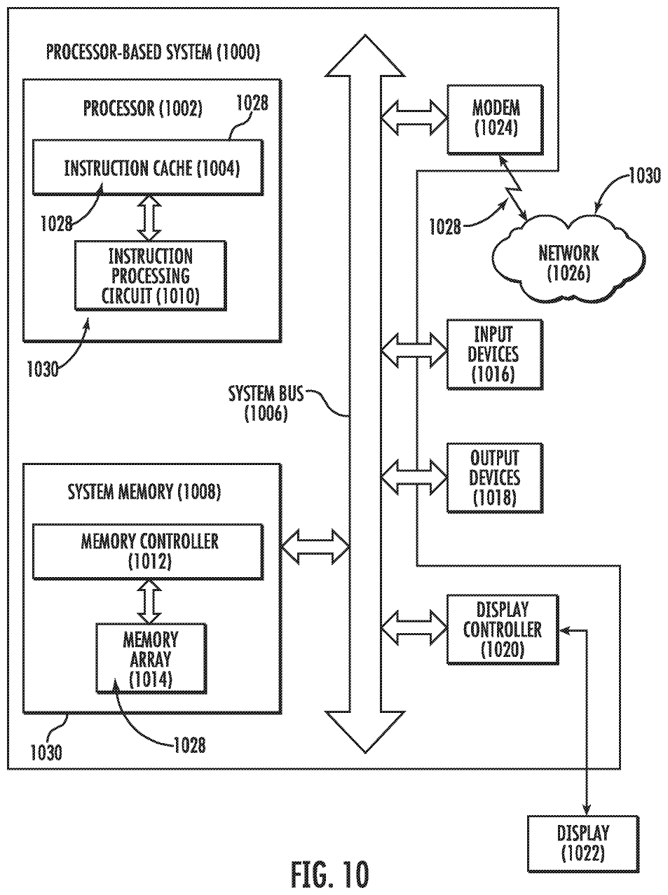

FIG. 10 is a block diagram of an exemplary processor-based system 1000 that includes a processor 1002 configured to support execution of compiler-optimized machine code based on runtime information about the processor 1002. For example, the processor 1002 in FIG. 10 could be the processor 104 in FIG. 2, and the processor-based system 1000 may be the same as the processor-based system 100 in FIG. 1 with further and/or alternative details shown. The processor-based system 1000 may be a circuit or circuits included in an electronic board card, such as, a printed circuit board (PCB), a server, a personal computer, a desktop computer, a laptop computer, a personal digital assistant (PDA), a computing pad, a mobile device, or any other device, and may represent, for example, a server or a user's computer. In this example, the processor-based system 1000 includes the processor 1002. The processor 1002 represents one or more general-purpose processing circuits, such as a microprocessor, central processing unit, or the like. More particularly, the processor 1002 may be an EDGE instruction set microprocessor, or other processor implementing an instruction set that supports explicit consumer naming for communicating produced values resulting from execution of producer instructions. The processor 1002 is configured to execute processing logic in instructions for performing the operations and steps discussed herein. In this example, the processor 1002 includes an instruction cache 1004 for temporary, fast access memory storage of instructions and an instruction processing circuit 1010. Fetched or prefetched instructions from a memory, such as from the system memory 1008 over a system bus 1006, are stored in the instruction cache 1004. The instruction processing circuit 1010 is configured to process instructions fetched into the instruction cache 1004 and process the instructions for execution. The instruction processing circuit 1010 is compatible with a reach-based explicit consumer communications model and instruction encoding such that the instruction processing circuit 1010 supports execution producer instructions encoded with reach-based explicit naming of consumer instructions such that these produced values are communicated as input values to the named consumer instructions for their execution.

The processor 1002 and the system memory 1008 are coupled to the system bus 1006 and can intercouple peripheral devices included in the processor-based system 1000. As is well known, the processor 1002 communicates with these other devices by exchanging address, control, and data information over the system bus 1006. For example, the processor 1002 can communicate bus transaction requests to a memory controller 1012 in the system memory 1008 as an example of a slave device. Although not illustrated in FIG. 10, multiple system buses 1006 could be provided, wherein each system bus 1006 constitutes a different fabric. In this example, the memory controller 1012 is configured to provide memory access requests to a memory array 1014 in the system memory 1008. The memory array is comprised of an array of storage bit cells for storing data. The system memory 1008 may be a read-only memory (ROM), flash memory, dynamic random access memory (DRAM), such as synchronous DRAM (SDRAM), etc., and a static memory (e.g., flash memory, static random access memory (SRAM), etc.), as non-limiting examples.

Other devices can be connected to the system bus 1006. As illustrated in FIG. 10, these devices can include the system memory 1008, one or more input device(s) 1016, one or more output device(s) 1018, a modem 1024, and one or more display controllers 1020, as examples. The input device(s) 1016 can include any type of input device, including but not limited to input keys, switches, voice processors, etc. The output device(s) 1018 can include any type of output device, including but not limited to audio, video, other visual indicators, etc. The modem 1024 can be any device configured to allow exchange of data to and from a network 1026. The network 1026 can be any type of network, including but not limited to a wired or wireless network, a private or public network, a local area network (LAN), a wireless local area network (WLAN), a wide area network (WAN), a BLUETOOTH™ network, and the Internet. The modem 1024 can be configured to support any type of communications protocol desired. The processor 1002 may also be configured to access the display controller(s) 1020 over the system bus 1006 to control information sent to one or more displays 1022. The display(s) 1022 can include any type of display, including but not limited to a cathode ray tube (CRT), a liquid crystal display (LCD), a plasma display, etc.

The processor-based system 1000 in FIG. 10 may include a set of instructions 1028 that may be encoded with the reach-based explicit consumer naming model to be executed by the processor 1002 for any application desired according to the instructions. The instructions 1028 may be stored in the system memory 1008, processor 1002, and/or instruction cache 1004 as examples of non-transitory computer-readable medium 1030. The instructions 1028 may also reside, completely or at least partially, within the system memory 1008 and/or within the processor 1002 during their execution. The instructions 1028 may further be transmitted or received over the network 1026 via the modem 1024, such that the network 1026 includes the computer-readable medium 1030.

While the computer-readable medium 1030 is shown in an exemplary embodiment to be a single medium, the term “computer-readable medium” should be taken to include a single medium or multiple media (e.g., a centralized or distributed database, and/or associated caches and servers) that store the one or more sets of instructions. The term “computer-readable medium” shall also be taken to include any medium that is capable of storing, encoding, or carrying a set of instructions for execution by the processing device and that cause the processing device to perform any one or more of the methodologies of the embodiments disclosed herein. The term “computer-readable medium” shall accordingly be taken to include, but not be limited to, solid-state memories, optical medium, and magnetic medium.

The embodiments disclosed herein include various steps. The steps of the embodiments disclosed herein may be formed by hardware components or may be embodied in machine-executable instructions, which may be used to cause a general-purpose or special-purpose processor programmed with the instructions to perform the steps. Alternatively, the steps may be performed by a combination of hardware and software.

The embodiments disclosed herein may be provided as a computer program product, or software, that may include a machine-readable medium (or computer-readable medium) having stored thereon instructions, which may be used to program a computer system (or other electronic devices) to perform a process according to the embodiments disclosed herein. A machine-readable medium includes any mechanism for storing or transmitting information in a form readable by a machine (e.g., a computer). For example, a machine-readable medium includes: a machine-readable storage medium (e.g., ROM, random access memory (“RAM”), a magnetic disk storage medium, an optical storage medium, flash memory devices, etc.); and the like.

Unless specifically stated otherwise and as apparent from the previous discussion, it is appreciated that throughout the description, discussions utilizing terms such as “processing,” “computing,” “determining,” “displaying,” or the like, refer to the action and processes of a computer system, or similar electronic computing device, that manipulates and transforms data and memories represented as physical (electronic) quantities within the computer system's registers into other data similarly represented as physical quantities within the computer system memories or registers or other such information storage, transmission, or display devices.

The algorithms and displays presented herein are not inherently related to any particular computer or other apparatus. Various systems may be used with programs in accordance with the teachings herein, or it may prove convenient to construct more specialized apparatuses to perform the required method steps. The required structure for a variety of these systems will appear from the description above. In addition, the embodiments described herein are not described with reference to any particular programming language. It will be appreciated that a variety of programming languages may be used to implement the teachings of the embodiments as described herein.

Those of skill in the art will further appreciate that the various illustrative logical blocks, modules, circuits, and algorithms described in connection with the embodiments disclosed herein may be implemented as electronic hardware, instructions stored in memory or in another computer-readable medium and executed by a processor or other processing device, or combinations of both. The components of the distributed antenna systems described herein may be employed in any circuit, hardware component, integrated circuit (IC), or IC chip, as examples. Memory disclosed herein may be any type and size of memory and may be configured to store any type of information desired. To clearly illustrate this interchangeability, various illustrative components, blocks, modules, circuits, and steps have been described above generally in terms of their functionality. How such functionality is implemented depends on the particular application, design choices, and/or design constraints imposed on the overall system. Skilled artisans may implement the described functionality in varying ways for each particular application, but such implementation decisions should not be interpreted as causing a departure from the scope of the present embodiments.

The various illustrative logical blocks, modules, and circuits described in connection with the embodiments disclosed herein may be implemented or performed with a processor, a Digital Signal Processor (DSP), an Application Specific Integrated Circuit (ASIC), a Field Programmable Gate Array (FPGA), or other programmable logic device, a discrete gate or transistor logic, discrete hardware components, or any combination thereof designed to perform the functions described herein. Furthermore, a controller may be a processor. A processor may be a microprocessor, but in the alternative, the processor may be any conventional processor, controller, microcontroller, or state machine. A processor may also be implemented as a combination of computing devices (e.g., a combination of a DSP and a microprocessor, a plurality of microprocessors, one or more microprocessors in conjunction with a DSP core, or any other such configuration).

The embodiments disclosed herein may be embodied in hardware and in instructions that are stored in hardware, and may reside, for example, in RAM, flash memory, ROM, Electrically Programmable ROM (EPROM), Electrically Erasable Programmable ROM (EEPROM), registers, a hard disk, a removable disk, a CD-ROM, or any other form of computer-readable medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a remote station. In the alternative, the processor and the storage medium may reside as discrete components in a remote station, base station, or server.

It is also noted that the operational steps described in any of the exemplary embodiments herein are described to provide examples and discussion. The operations described may be performed in numerous different sequences other than the illustrated sequences. Furthermore, operations described in a single operational step may actually be performed in a number of different steps. Additionally, one or more operational steps discussed in the exemplary embodiments may be combined. Those of skill in the art will also understand that information and signals may be represented using any of a variety of technologies and techniques. For example, data, instructions, commands, information, signals, bits, symbols, and chips, that may be references throughout the above description, may be represented by voltages, currents, electromagnetic waves, magnetic fields, or particles, optical fields or particles, or any combination thereof.

Unless otherwise expressly stated, it is in no way intended that any method set forth herein be construed as requiring that its steps be performed in a specific order. Accordingly, where a method claim does not actually recite an order to be followed by its steps, or it is not otherwise specifically stated in the claims or descriptions that the steps are to be limited to a specific order, it is in no way intended that any particular order be inferred.

It will be apparent to those skilled in the art that various modifications and variations can be made without departing from the spirit or scope of the invention. Since modifications, combinations, sub-combinations and variations of the disclosed embodiments incorporating the spirit and substance of the invention may occur to persons skilled in the art, the invention should be construed to include everything within the scope of the appended claims and their equivalents.

What is claimed is:

1. A processor-based system, comprising:
a processor configured to:
fetch one or more instructions from an instruction memory, comprising:
a conditional branch instruction comprising a condition operand corresponding to runtime information about the processor-based system and a target address operand; and
at least one of:
a first compiler generated instruction block at the target address of the conditional branch instruction; and
a second compiler generated instruction block following the conditional branch instruction;
process the conditional branch instruction to determine a condition of the condition operand based on the runtime information about the processor-based system; and
in response to the determined condition indicating a branch taken, execute the first compiler generated instruction block.

2. The processor-based system of claim 1, wherein the runtime information about the processor-based system comprises information available to the processor at the time of execution of the one or more instructions that was not known at the time the one or more instructions were generated by a compiler.

3. The processor-based system of claim 1, wherein the processor is further configured to, in response to the determined condition indicating a branch not taken, execute the second compiler generated instruction block.

4. The processor-based system of claim 1, wherein the first compiler generated instruction block and the second compiler generated instruction block are functionally equivalent.

5. The processor-based system of claim 4, wherein:
the first compiler generated instruction block is generated by the compiler without compiler optimizations; and
the second compiler generated instruction block is generated by the compiler using at least one compiler optimization.

6. The processor-based system of claim 4, wherein the runtime information about the processor-based system comprises information about the processor-based system before the first compiler generated instruction block is executed and information about the processor-based system after the first compiler generated instruction block is executed.

7. The processor-based system of claim 1, wherein the runtime information about the processor-based system includes a performance characteristic of the processor-based system.

8. The processor-based system of claim 1, wherein the runtime about the processor-based system includes information includes information about a hardware resource of the processor-based system.

9. The processor-based system of claim 1, wherein the runtime information about the processor-based system comprises at least two different pieces of information about the processor-based system.

10. A method of operating a processor in a processor-based system, comprising:
fetching one or more instructions from an instruction memory, comprising:
a conditional branch instruction comprising a condition operand corresponding to runtime information about the processor-based system and a target address operand; and
at least one of:
a first compiler generated instruction block at the target address of the conditional branch instruction; and
a second compiler generated instruction block following the conditional branch instruction;
processing the conditional branch instruction to determine if a condition of the condition operand based on the runtime information about the processor-based system; and
in response to the determined condition indicating a branch taken, execute the first compiler generated instruction block.

11. The method of claim 10 wherein the runtime information about the processor-based system comprises information available to the processor at the time of execution of the one or more instructions that was not known at the time the one or more instructions were generated by the compiler.

12. The method of claim 10, further comprising in response to the determined condition not indicating a branch not taken, executing the second compiler generated instruction block.

13. A method of generating instructions for execution by a processor in a processor-based system, comprising:
receiving source code; and
generating the instructions from the source code, the instructions comprising:
a conditional branch instruction comprising a condition operand corresponding to runtime information about the processor-based system and a target address operand;
a first compiler generated instruction block at the target address of the conditional branch instruction; and
a second compiler generated instruction block following the conditional branch instruction.

14. The method of claim 13, wherein the runtime information about the processor-based system comprises information available to the processor at the time of execution of the one or more instructions that was not known at the time the one or more instructions were generated.

15. The method of claim 13, wherein the first compiler generated instruction block and the second compiler generated instruction block are functionally equivalent.

16. The method of claim 15, wherein:
the first compiler generated instruction block is generated without compiler optimizations; and
the second compiler generated instruction block is generated using at least one compiler optimization.

17. The method of claim 13, wherein the runtime information about the processor-based system comprises information about the processor-based system before the first compiler generated instruction block is executed and information about the processor-based system after the first compiler generated instruction block is executed.

18. The method of claim 13, wherein the runtime information about the processor-based system includes a performance characteristic of the processor.

19. The method of claim 13, wherein the runtime about the processor-based system includes information about a hardware resource of the processor.

20. The method of claim 13, wherein the runtime information about the processor-based system comprises at least two different pieces of information about the processor-based system.
